(19) United States
(12) Patent Application Publication
(10) Pub. No.: US 2011/0094328 A1
(43) Pub. Date: Apr. 28, 2011

(54) BUTTON ASSEMBLY AND METHOD OF MANUFACTURING BUTTON SHAFT FOR BUTTON ASSEMBLY

(75) Inventor: Jong-sub Lee, Seoul (KR)

(73) Assignee: Samsung Electronics Co., Ltd., Suwon-si (KR)

(21) Appl. No.: 12/912,898

(22) Filed: Oct. 27, 2010

(30) Foreign Application Priority Data
Oct. 27, 2009 (KR) 10-2009-0102283

(51) Int. Cl. G05G 1/02; B28B 7/20

(52) U.S. Cl. 74/491; 264/318

(57) ABSTRACT

To solve a tilting of a button in electronic information devices, there is provided a button assembly comprising: a housing with a guide surface formed inside thereof and extending along a direction; a button shaft slidably inserted into the guide surface, and comprising a first recess formed in an outer circumferential surface thereof; a washer inserted into the first recess, and preventing an outward ejection of the button shaft in the guide surface; and an elastic member that biases the button shaft outward, wherein the button shaft comprises a second recess formed adjacent to the first recess and a method of manufacturing a button shaft for a button assembly.

### CROSS-REFERENCE TO RELATED PATENT APPLICATION

This application claims the benefit of Korean Patent Application No. 10-2009-0102283, filed on Oct. 27, 2009, in the Korean Intellectual Property Office, the disclosure of which is incorporated herein in its entirety by reference.

### BACKGROUND

Embodiments of the present invention relate to a button assembly and a method of manufacturing a button shaft for a button assembly.

Button assemblies include buttons and are used in various kinds of electronic information appliances, such as digital cameras, camcorders, MP3 players, portable multimedia players (PMPs), and the like. When a user presses a button of a button assembly and then releases the button, the button returns to its original position. For this configuration, a button assembly includes an elastic member that biases a button upward, and a washer that prevents the button from ejecting upward.

### SUMMARY

According to an embodiment of the invention, there is provided a button assembly comprising: a housing with a guide surface formed inside thereof and extending along a direction; a button shaft slidably inserted into the guide surface, and comprising a first recess formed in an outer circumferential surface thereof; a washer inserted into the first recess that prevents an outward ejection of the button shaft in the guide surface; and an elastic member that biases the button shaft outward, wherein the button shaft comprises a second recess formed adjacent to the first recess.

Although a cleavage is formed at the contact surface between a sliding core and a lower mold, a recess for a washer formed in a button shaft does not have a burr. Thus, a tilting of a button may be prevented, and the quality of image photographing devices, such as cameras may be enhanced.

The first recess and the second recess may be parallel to each other and respectively formed in the outer circumferential surface of the button shaft.

The first recess and the second recess need not be spaced apart from each other in a longitudinal direction of the button shaft. A depth of the first recess may be smaller than a depth of the second recess.

The first recess and the second recess may be spaced apart from each other in a longitudinal direction of the button shaft. In this regard, a depth of the first recess may be the same as or different from a depth of the second recess.

The button assembly may further comprise a button head coupled to a top portion of the button shaft, wherein the elastic member comprises a conical coil spring positioned between the button head and the housing.

The washer may be in a shape of a doughnut, a part of which is cut, and cut portions of the washer are displaced with respect to each other so as to be inserted into the button shaft.

The button assembly may be used as a release button for an image photographing device, but is not limited thereto.

According to another aspect of the present invention, there is provided a method of manufacturing a button shaft for a button assembly by forming a recess for a washer in the button shaft movably inserted into an internal guide surface of a housing, the method comprising: arranging a lower mold and a sliding core to be used to perform injection molding of the button shaft; injecting a raw material into the lower mold and the sliding core; and moving the sliding core in a radial direction from a center of the button shaft, wherein a parting line corresponding to a contact surface between the lower mold and the sliding core is formed at a height different from a height of a bottom surface of the recess for a washer into which the washer is inserted.

The button shaft may be made of a material comprising polycarbonate (PC).

### BRIEF DESCRIPTION OF THE DRAWINGS

The above and other features and advantages of the present invention will become more apparent by describing in detail exemplary embodiments thereof with reference to the attached drawings in which:

FIG. 1 is a side cross-sectional view of a button assembly according to an embodiment of the present invention;

FIG. 2 is a perspective view illustrating coupling between a button part and a washer in the button assembly of FIG. 1;

FIG. 3 is a side cross-sectional view of a button assembly according to another embodiment of the present invention;

FIGS. 4A through 4C are side cross-sectional views illustrating a method of manufacturing a button shaft for an image photographing device, according to an embodiment of the present invention;

FIG. 5 is an enlarged side cross-sectional view of a region represented by a dashed double-dotted line of FIG. 4B, according to an embodiment of the present invention; and

FIG. 6 is an enlarged side cross-sectional view illustrating a portion of a manufactured button shaft for an image photographing device corresponding to the region of FIG. 5, according to an embodiment of the present invention.

### DETAILED DESCRIPTION

Embodiments of the present invention will now be described in more detail with reference to the accompanying drawings.

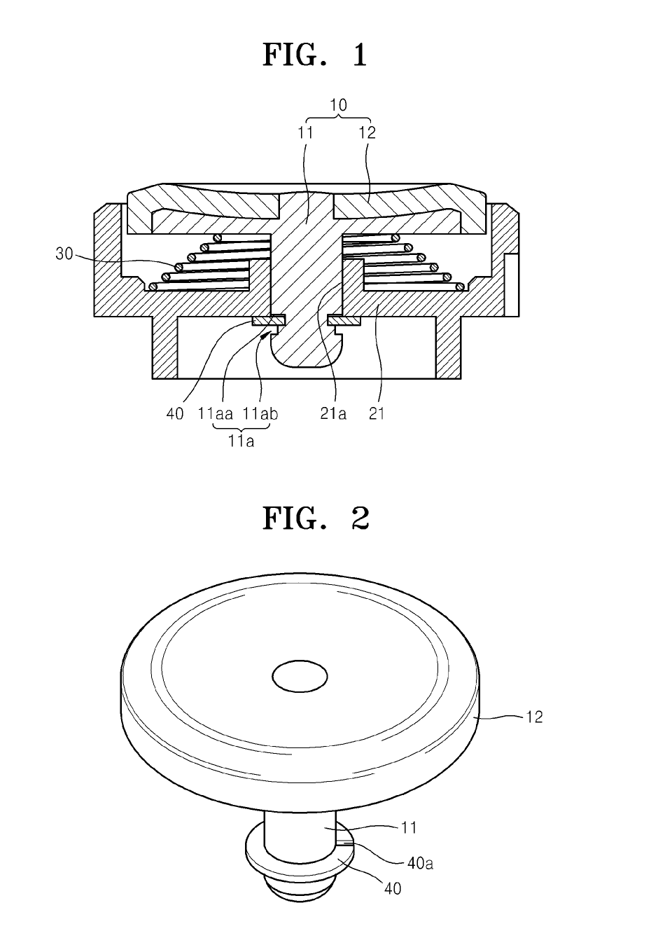

FIG. 1 is a side cross-sectional view of a button assembly according to an embodiment of the present invention. FIG. 2 is a view illustrating coupling between a button part and a washer in the button assembly of FIG. 1. Referring to FIGS. 1 and 2, the button assembly includes a button part 10, a housing 21, a washer 40, and an elastic member 30. The button part 10 includes a button shaft 11 and a button head 12. The button shaft 11 is slidably inserted into a guide surface 21a of the housing 21. The elastic member 30, for example, a conical coil spring, is inserted between the button head 12 of the button part 10 and an internal surface of the housing 21, so that the button part 10 is biased outward, that is, in an external direction of a digital image photographing device including the button assembly. The button shaft 11 includes a recess 11a for a washer, and the washer 40 is inserted into the recess 11a. The washer 40 prevents the button part 10 from ejecting outward. When the button part 10 is pressed inward by a user and then released, the button part 10 returns to its original position by cooperative operation of the elastic member 30 and the washer 40.

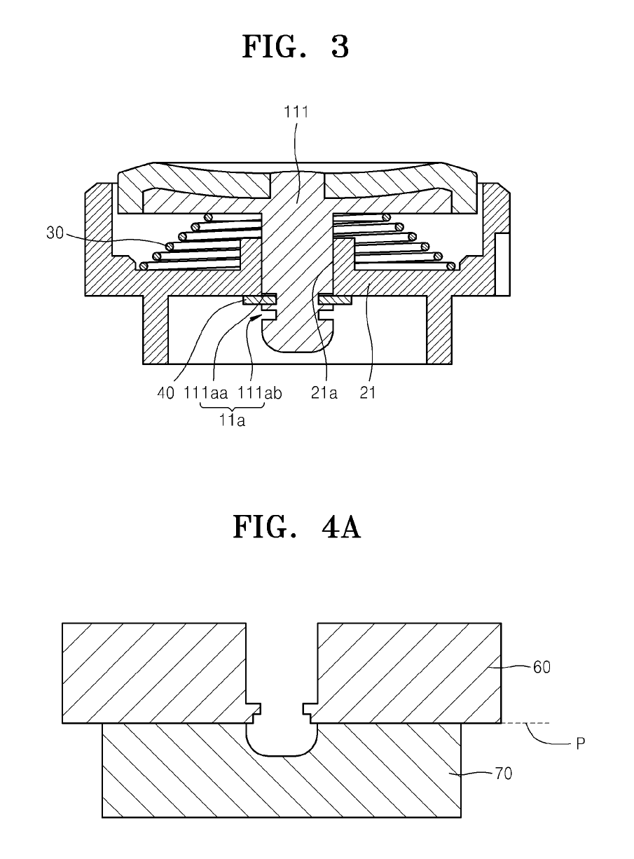

The recess 11a includes a first recess 11aa and a second recess 11ab that are adjacent to each other. The term “adjacent to each other” as used herein may be understood to include that as illustrated in FIG. 1, wherein the first and second recesses 11aa and 11ab contact each other, and as illustrated in FIG. 3, wherein first and second recesses 111aa and 111ab are spaced apart from each other at a constant distance in a longitudinal direction of a button shaft 111—however, this term is not limited to the exemplary embodiments illustrated, and should be construed according to its plain and ordinary meaning.

The first and second recesses 11aa and 11ab are respectively formed in an outer circumferential surface of the button shaft 11, and are parallel to each other. The depth of the first recess 11aa may be different from the depth of the second recess 11ab, as illustrated in FIG. 1. As illustrated in FIG. 3, the depth of the first recess 11aa may be the same as the depth of the second recess 11ab. The first recess 11aa is not spaced apart from the second recess 11ab, as illustrated in FIG. 1, and the depth of the first recess 11aa needs to be greater than the depth of the second recess 11ab. On the other hand, the first recess 111aa is spaced apart from the second recess 111ab as illustrated in FIG. 3, and the depths of the first and second recesses 111aa and 111ab do not matter.

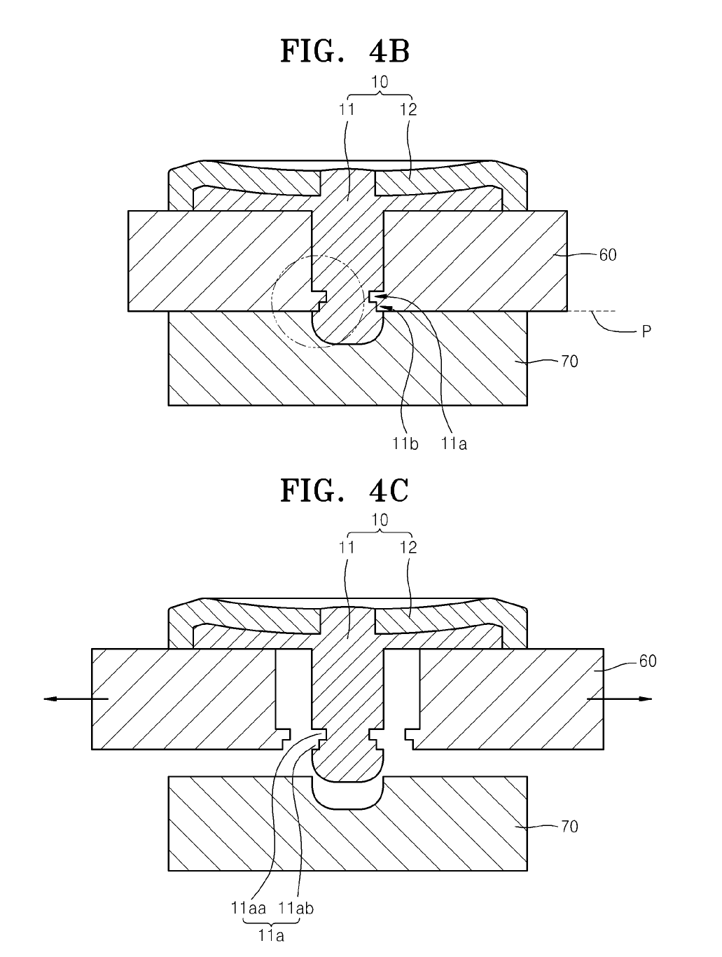

The first recess 11aa or 111aa and the second recess 11ab or 111ab of the recess 11a or 111a, respectively, are formed so that a contact surface between the washer 40 and the recess 11a or 111a is not formed in a position corresponding to a parting line P (FIG. 4B) that corresponds to an interface between a sliding core 60 (FIG. 4B) and a lower mold, which will later be described. Embodiments of the recess 11a, including the first and second recesses 11aa and 11ab, and the recess 111a, including the first and second recesses 111aa and 111ab, are illustrated in FIGS. 1 and 3, but are not limited thereto. In other words, the recess 11a may be any recess for a washer with a shape that allows a bottom surface of the recess 11a, which contacts the washer 40, not to be formed in a position corresponding to the parting line P.

The button shaft 11 and the button head 12 of the button part 10 may be made of different materials. For example, the button shaft 11 may be made of polycarbonate (PC), and the button head 12 may be made of a plated acrylonitrile-butadiene-styrene (ABS) plastic. When the button part 10 is made of two different kinds of plastics, the button part 10 may be prepared by double injection molding. However, the button part 10 is not limited thereto, and the button part 10 may be made of the same material.

The button assembly may be used as a release button in image photographing devices, such as digital cameras or camcorders. Thus, an appearance of the button assembly may be enhanced by plating the button head 12 of the button part 10 with a metal, such as chrome or nickel.

The elastic member 30 is illustrated in FIGS. 1 and 3 as a conical coil spring, but is not limited thereto. The elastic member 30 may be any elastic member that provides the button shaft 11 with an elastic force capable of biasing the button shaft 11 outward.

The washer 40 is in a shape of a doughnut, a part of which is cut. In other words, the washer 40 may in the form of a C-ring. The inside diameter of the washer 40 may be greater than or the same as that of the first recess 11aa, and may be smaller than the diameter of the button shaft 11. Thus, when a user holds cut portions 40a of the washer 40, twists the cut portions 40a in opposite directions to each other, and then inserts the washer 40 into the button shaft 11, the shape of the washer 40 returns to its original shape by a resilient force.

FIGS. 4A through 4C are views illustrating a method of manufacturing a button shaft for an image photographing device, according to an embodiment of the present invention.

First, a lower mold 70 and a sliding core 60 are arranged (refer to FIG. 4A). The lower mold 70 and the sliding core 60 are used to perform injection molding of the button shaft 11. The lower mold 70 and the sliding core 60 are disposed to about on each other, and the contact surface between the lower mold 70 and the sliding core 60 defines the parting line P. For convenience for illustration, an upper mold is not illustrated herein.

A melted plastic is injected into a space formed in the sliding core 60 and the lower mold 70 (refer to FIG. 4B). Although not illustrated in FIG. 4B, the button head 12 of the button part 10 may be formed in a space formed in the upper mold (not shown) and the sliding core 60. When the button head 12 is formed of a material different from that of the button shaft 11, the button part 10 may be prepared by double injection molding.

After the injection of the melted plastic, the sliding core 60 is removed to form the button shaft 11 including the recess 11a (refer to FIG. 4C).

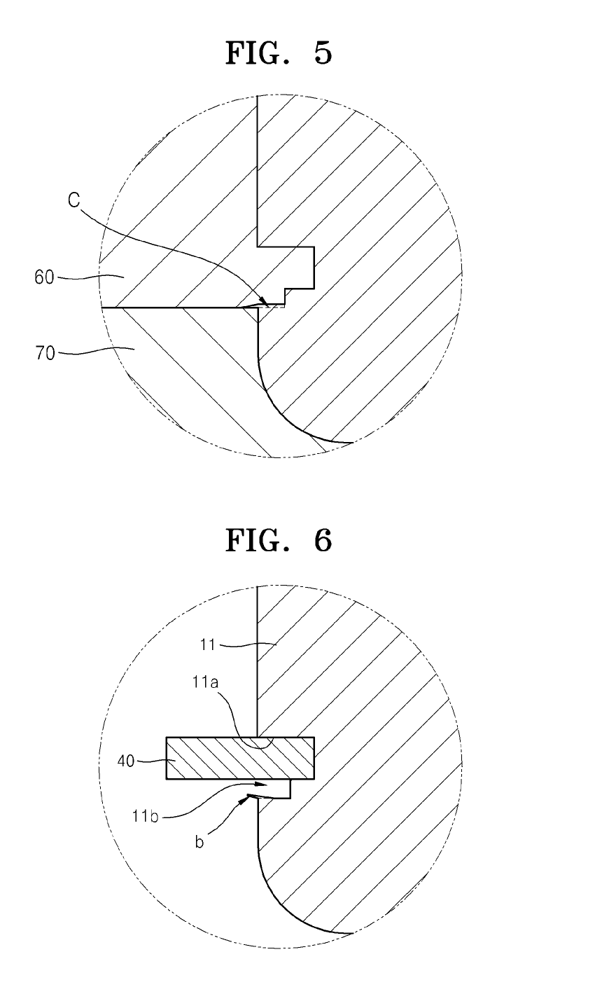

FIG. 5 is an enlarged view of a region represented by a dashed double-dotted line of FIG. 4B, according to an embodiment of the present invention. FIG. 6 is a view illustrating a portion of a manufactured button shaft for an image photographing device the portion corresponding to the region of FIG. 5, according to an embodiment of the present invention. Referring to FIG. 5, the sliding core 60 has a surface recessed at the parting line P. As illustrated in FIG. 5, due to repetitive injection molding, a cleavage C may be formed at the contact surface between the sliding core 60 and the lower mold 70 in which the interface between the sliding core 60 and the lower mold 70 is supposed to be smoothly formed corresponding to the parting line P. In other words, the mold structure may be defective. As illustrated in FIG. 6, the button shaft has a burr b corresponding to the parting line P. In particular, when a surface of a recess in which the washer 40 is inserted thereto is formed has the burr b, the inserted washer 40 is tilted, and thus the appearance of the button assembly is defective. In addition, the cleavage C between the sliding core 60 and the lower mold 70 grows bigger with time passing by, and thus the defective appearance of the button part 10 caused by the burr b is more serious.

Referring to FIG. 4B, a bottom surface of the first recess 11aa of the button shaft 11 into which the washer 40 is inserted is formed above the parting line P. That is, in the injection molding, the recess 11a includes the first recess 11aa and the second recess 11ab formed adjacent to the first recess 11aa so that the bottom surface of the first recess 11aa of the button shaft 11 into which the washer 40 is inserted is not positioned at a height corresponding to the parting line P. A bottom surface of the second recess 11ab is positioned at a height corresponding to the parting line P. In this regard, the washer 40 is not inserted into the second recess 11ab, and thus, although the bottom surface of the second recess 11ab has the burr b, the washer 40 is not tilted. Since the recess 11a of the button shaft 11 does not have the burr b, although the cleavage C may be formed at the contact surface between the sliding core 60 and the lower mold 70 due to repetitive injection molding, the productivity the button assembly may increase and the quality of image photographing devices may be enhanced.

For example, a button assembly according to one or more embodiments of the present invention may be used in image photographing devices and various kinds of electronic information devices. In addition, a button shaft of the button assembly may be prepared by die casting using at least two molds.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of components configured to perform the specified functions. The particular implementations shown and described herein are illustrative examples of the invention and are not intended to otherwise limit the scope of the invention in any way. For the sake of brevity, conventional aspects may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) are to be construed to cover both the singular and the plural. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

The words “mechanism” and “element” are intended to be used generally and are not limited solely to mechanical embodiments. Numerous modifications and adaptations will be readily apparent to those skilled in this art without departing from the spirit and scope of the present invention.

What is claimed is:

1. A button assembly comprising:
a housing with a guide surface formed inside thereof and extending along a direction;
a button shaft slidably inserted into the guide surface, and comprising a first recess formed in an outer circumferential surface thereof;
a washer inserted into the first recess that prevents an outward ejection of the button shaft in the guide surface; and
an elastic member that biases the button shaft outward;
wherein the button shaft comprises a second recess formed adjacent to the first recess.

2. The button assembly of claim 1, wherein the first recess and the second recess are parallel to each other and are respectively formed in the outer circumferential surface of the button shaft.

3. The button assembly of claim 1, wherein the first recess and the second recess are not spaced apart from each other in a longitudinal direction of the button shaft.

4. The button assembly of claim 3, wherein a depth of the first recess is smaller than a depth of the second recess.

5. The button assembly of claim 1, wherein the first recess and the second recess are spaced apart from each other in a longitudinal direction of the button shaft.

6. The button assembly of claim 1, further comprising a button head coupled to a top portion of the button shaft,
wherein the elastic member comprises a conical coil spring positioned between the button head and the housing.

7. The button assembly of claim 1, wherein the washer is in a shape of a doughnut, a part of which is cut, and cut portions of the washer are displaced with respect to each other for insertion into the button shaft.

8. The button assembly of claim 1, configured as a release button for an image photographing device.

9. A method of manufacturing a button shaft for a button assembly by forming a recess for a washer in the button shaft slidably inserted into an internal guide surface of a housing, the method comprising:
arranging a lower mold and a sliding core to be used to perform injection molding of the button shaft;
injecting a raw material into the lower mold and the sliding core; and
moving the sliding core in a radial direction from a center of the button shaft,
wherein a parting line corresponding to a contact surface between the lower mold and the sliding core is formed at a height different from a height of a bottom surface of the recess for a washer into which the washer is inserted.

10. A method of manufacturing a button shaft for a button assembly for an image photographing device, the button shaft being made of a material comprising polycarbonate (PC).
